(19) United States
(12) Patent Application Publication
(10) Pub. No.: US 2013/0094095 A1
(43) Pub. Date: Apr. 18, 2013

(54) PROJECTION ZOOM LENS

(71) Applicant: SEIKO EPSON CORPORATION, Tokyo (JP)

(72) Inventor: Nobutaka MINEFUJI, Azumino-shi (JP)

(73) Assignee: SEIKO EPSON CORPORATION, Tokyo (JP)

(21) Appl. No.: 13/650,612

(22) Filed: Oct. 12, 2012

(30) Foreign Application Priority Data
Oct. 17, 2011 (JP) 2011-227663

(51) Int. Cl. G02B 15/14

(52) U.S. Cl. 359/680

(57) ABSTRACT

When at least two resin lenses having oppositely signed power factors are disposed in positions that are not relatively far away from each other in a lens group disposed on a high magnification side with respect to an aperture stop, the difference in temperature between the two resin lenses can be reduced, whereby the amount of change in the focal point of an overall projection zoom lens can be reduced. The lens groups on the high magnification side with respect to the aperture stop, which are close to the atmosphere, experience a relatively small increase in temperature when in use. The focus shift due to variation in temperature can therefore be reliably reduced by disposing the resin lenses, which are readily affected by an increase in temperature, on the high magnification side with respect to the aperture stop.

### BACKGROUND

1. Technical Field

The present invention relates to a projection zoom lens that is appropriately incorporated into a projector that enlarges and projects an image formed on an image display device.

2. Related Art

An optical system for a projector that enlarges and projects an image formed on an image display device needs to have (1) a long back focal length that allows a prism for combining light fluxes from three liquid crystal panels for red, green, and blue color components to be disposed, (2) a satisfactory telocentric characteristic that prevents color unevenness from occurring, and (3) a small f-number, that is, a bright optical system that allows light from an illumination system to be efficiently introduced. In an optical system of this type, that is, a projection zoom lens of this type, an aspheric lens has been increasingly used not only to improve performance but also to reduce the number of lenses for cost reduction purposes and efficiently correct aberrations an the same time. There are several known aspheric lenses, such as a glass mold aspheric lens produced by molding a glass material, a complex aspheric lens produced by forming a thin aspheric resin layer on a surface of a glass spherical lens, and a resin mold lens produced by molding a resin material in an injection molding process.

In a projection zoom lens, a large-aperture aspheric lens is disposed on a high magnification side in many cases to reduce the amount of distortion of a projected image. A glass mold aspheric lens is, however, disadvantageous in that it is difficult to form a large-aperture lens and hence the resultant lens is very expensive. A complex aspheric lens, which is less expensive than a glass mold aspheric lens, is still expensive as compared with a resin mold lens, which will be described later, because a complex aspheric lens is based on a glass spherical lens. A complex aspheric lens is also disadvantageous, for example, in that the aspheric surface is limited to certain shapes because a thin resin layer is used to form the aspheric stir face. Since a resin mold aspheric lens can be readily molded than the two aspheric lenses described above, and a large-aperture lens can be molded at a relatively inexpensive cost, a resin mold lens is used in a cost-oriented projection zoom lens in many cases.

A resin material, however, has a problem with its thermal characteristics, that is, dependence of the coefficient of linear expansion and the refractive index on temperature being inferior to those of a glass material by about one order. That is, a lens made of a resin disadvantageously tends to cause a focus shift, for example, when the temperature of the environment where the lens is used changes or when the temperature inside the lens in use increases.

A shift of the focal point of a lens caused by a change in temperature conceivably results from a change in overall temperature of the lens due to a change in environment temperature; an increase in temperature due to light outputted front an image display panel, incident on a projection zoom lens, and absorbed by the lens itself; an increase in temperature due to unwanted light incident on the interior of a lens barrel; and other factors.

A projector in recent years, which is required to increase the brightness of an image so that the projector can be used even in a bright environment, uses a method for increasing effective light transmittance efficiency of an image display panel by placing microlenses or any other component immediately in front of the pixels to reduce the amount of light blocked by a mask portion of the image display panel. In this case, however, light that exits from the image display panel diffuses beyond the angle formed by the f-number of an illumination system, and part of the diffused light impinges on the inner wall of a barrel of the projection lens and other components and contributes to an increase in temperature in the projection lens, resulting in a temperature difference inside the projection lens.

JP-A-2005-266103 and JP-A-2010-190939 disclose related art examples of a projection zoom lens using a resin mold aspheric lens of the type described above.

JP-A-2005-266103 discloses an example of a projection lens formed of a plurality of resin lenses. In the example, negative and positive lenses produced by molding a resin are so combined with each other that focus shifts produced by the two lenses due to a change in temperature cancel each other. The structure in which, the negative and positive lenses cancel the focus shifts with respect to each other is advantageous in that each of the resin lenses themselves can have a certain amount of power.

However, in the example described in JP-A-2005-266103, in which the negative resin lens and the positive resin lens are disposed on the high magnification side and the low magnification side respectively with respect to an aperture stop of the projection lens, a large focus shift occurs when the overall temperature of the projection lens changes, for example, when the environment temperature changes. The large focus shift is inevitably produced even when the power factors of the front and rear lenses are so appropriately distributed that focus shifts produced by the lenses cancel each other but when there is a difference in temperature between front and rear portions of the projection lens as described above.

When a single resin lens is used, it has been a frequent practice to reduce the effect of a change in temperature, for example, on a focus shift by sufficiently reducing or lowering the power of the resin lens itself.

JP-A-2010-190939 describes an example of a projection lens including a resin lens having relatively low power as described above and hence less affected by a change in temperature. It is, however, difficult to form a resin lens having no power at all, and a focus shift and other problems eventually occur when the temperature of the resin lens greatly increases. The effect of the temperature can be reduced by forming a resin lens having nearly zero power, and the power of the resin lens can be further effectively reduced by increasing the power of spherical lenses disposed on opposite sides of the resin lens. In this case, however, it is difficult to correct aberrations, and it is therefore necessary to add a spherical lens, which is not preferable because the additional lens causes increase in cost.

### SUMMARY

An advantage of some aspects of the invention is to provide a projection zoom lens including a resin lens that allows a projector to be not only manufactured at a low cost and capable of projecting a bright image but also unlikely to be affected by any difference in temperature produced in the projection zoom lens.

An aspect or the invention is directed to a projection zoom lens including at least the following three lens groups; a first lens group disposed on the enlargement side, fixed at the time of zooming, and having negative power, a last lens group disposed on the reduction side, fixed at the time of zooming, and having positive power, and a movable lens group disposed between the first lens group and the last lens group and moved for scorning. The projection zoom lens is substantially telecentric on the low magnification side. An aperture stop is provided in the movable lens group provided for the zooming. A plurality of resin lenses are provided across the first lens group to the last lens group. At least two resin lenses having oppositely signed power factors among the plurality of resin lenses are disposed in a lens group on the high, magnification side with respect to the aperture stop.

In the projection zoom lens according to the aspect of the invention, since at least two resin lenses having oppositely signed power factors are disposed in a lens group on the high magnification side with respect to the aperture stop, the two resin lenses having oppositely signed power factors are disposed in positions than are not relatively far away from each other, whereby the amount of change in focus can be reduced. In particular, since the lens groups on the high magnification side with respect to the aperture stop are unlikely to be affected by heat generated in the vicinity of the aperture stop because they are close to the atmosphere, the amount of focus shift due to a change in temperature can reliably be reduced by disposing the two resin lenses having oppositely signed power factors, which are likely to be affected by an increase in temperature, on the high magnification side with respect to the aperture stop.

According to a specific aspect of the invention, in the projection zoom lens described above, the at least two resin lenses having oppositely signed power factors may be disposed in a single lens group. When the two resin lenses having oppositely signed power factors are disposed close to each other as described above, the difference in temperature between the reins lenses can be reduced, whereby the amount of focus change can be reduced even when a difference in temperature is produced in the projection scorn lens in use.

According to another specific aspect of the invention, the at least two resin lenses having oppositely signed power factors may be disposed in lens groups disposed adjacent to each other.

According to still another specific aspect of the invention, the at least two resin lenses having oppositely signed power factors may be disposed adjacent to each other.

According to yet another specific aspect of the invention, the at least two resin lenses having oppositely signed power factors may be a negative resin lens having negative power and a positive resin lens having positive power sequentially arranged from the high magnification side. In this case, a retrofocus-type projection zoom lens can be readily configured, and the negative resin lens can correct distortion appropriately.

According to still yet another specific aspect of the invention, the negative resin lens disposed on the high magnification side and having negative power may be a negative lens having a concave surface facing the low magnification side, and the positive resin lens disposed on the low magnification side and having positive power may be a positive lens having a convex surface facing the high magnification side. In this case, since the concave and convex opposing surfaces of the negative and positive lenses work together, light rays that diverge at the concave surface of the negative lens are incident on the following convex surface, where the amount of aberrations is suppressed, whereby the aberrations are readily corrected.

According to further another specific aspect of the invention, when the low-magnification-side concave surface of the negative resin lens disposed on the high magnification side and having the negative power has a radius of curvature Rn, and the high-magnification-side convex surface of the positive resin lens disposed on the low magnification side and having the positive power has a radius of curvature Hp, the following conditional expression (1) is satisfied.

0.0<Rn/Rp<1.0 (1)

The conditional expression (1) defines a condition on the shapes of the resin lenses disposed on the high magnification side with respect to the aperture stop. When the low-magnification-side concave surface of the negative resin lens disposed on the high magnification side, which can efficiently suppress distortion when it has an aspheric surface, and the high-magnification-side convex surface of the positive resin lens disposed in the vicinity of the negative resin lens satisfy the conditional expression (1), distortion, field curvature, and astigmatism can be efficiently corrected.

If Rn/Rp is greater than the upper limit of the conditional expression (1) and the radius of curvature of the negative resin lens is much greater than the radius of curvature of the positive resin lens, it makes it difficult to suppress distortion and causes coma flare, thus such a configuration is not preferable.

Conversely, when Rn/Rp is smaller than the lower limit of the conditional expression (1) and the radius of curvature of the negative resin lens is much smaller than the radius of curvature of the positive resin lens, the high-magnification-side surface of the positive resin lens has a concave shape, which makes it difficult to correct field curvature and astigmatism and it is hence difficult to produce a satisfactorily flat image plane.

### BRIEF DESCRIPTION OF THE DRAWINGS

The invention will, be described with reference to the accompanying drawings, wherein like numbers reference like elements.

FIG. 1 shows a schematic configuration of a projector into which a projection room, lens according to an embodiment is incorporated.

FIGS. 2d and 2B are cross-sectional, views for describing the structure of the projection zoom lens incorporated into the projector. FIG. 2A shows a wide angle end state and FIG. 2B shows a telescopic end state.

FIG. 3A is a cross-sectional view for describing the state of light fluxes in the projection room lens operating at the wide angle end, and FIG. 3B is a cross-sectional view for describing the state of the light fluxes in the projection zoom lens operating at the telescopic end.

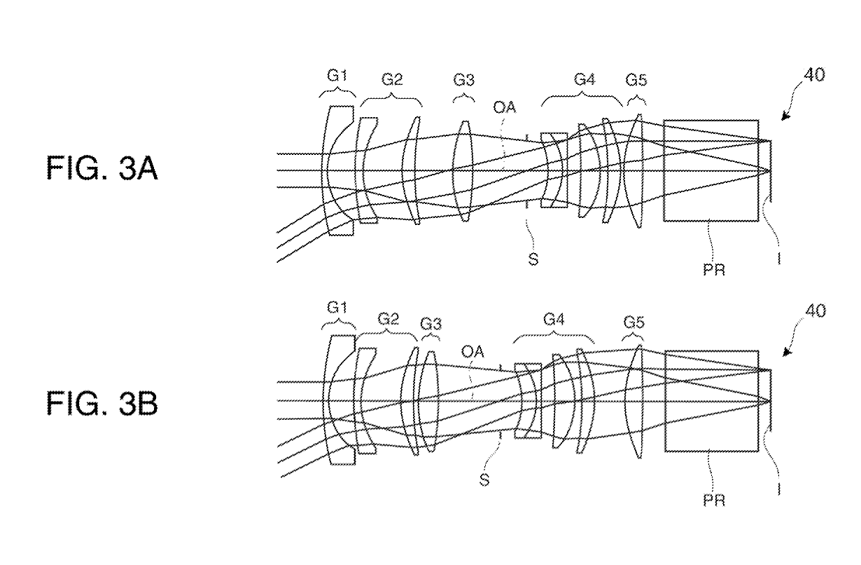

FIGS. 4A and 4B are cross-sectional views of a projection zoom lens according to Example 1.

FIGS. 5A to 5C show aberrations produced by the zoom lens according to Example 1.

FIGS. 6A and 68 are cross-sectional views of a projection zoom lens according to Example 2,

FIGS. 7A to 7C show aberrations produced by the zoom lens according to Example 2.

FIGS. 8A and 8B are cross-sectional views of a projection zoom lens according to Example 3.

FIGS. 9A to 9C show aberrations produced by the zoom lens according to Example 3.

FIGS. 10A and 10B are cross-sectional views of a projection zoom lens according to Example 4.

FIGS. 11A to 11C show aberrations produced by the zoom lens according to Example 4,

FIGS. 12a and 128 are cross-sectional views of a projection zoom lens according to Example 5.

FIGS. 13A to 13C show aberrations produced by the zoom lens according to Example 5.

FIGS. 14A and 14B are cross-sectional views of a projection zoom lens according to Example 6.

FIGS. 15A to 15C show aberrations produced by the zoom lens according to Example 6,

FIGS. 16A and 16B are cross-sectional views of a projection zoom lens according to Reference Example.

### DESCRIPTION OF EXEMPLARY EMBODIMENTS

A projection zoom lens according to an embodiment of the invention will be described below in detail with reference to the drawings.

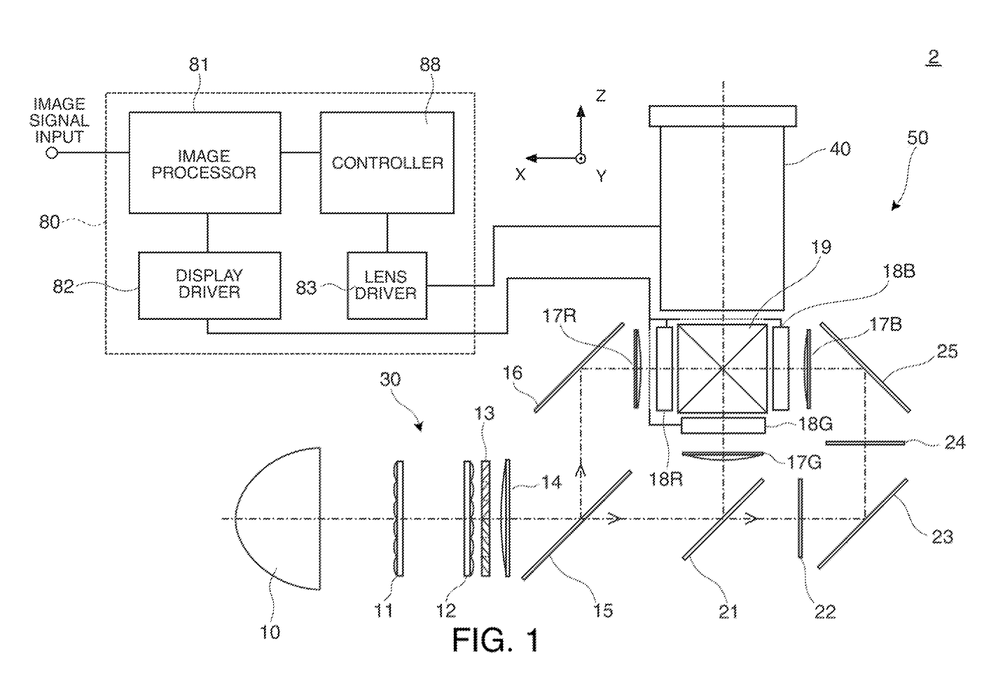

A projector 2 into which the projection scorn lens according to the embodiment of the invention is incorporated includes an optical system portion 50 that projects image light and a circuit apparatus 50 that controls the operation of the optical system, portion 50, as shown in FIG. 1.

In the optical system portion 50, a light source 10 is, for example, an ultrahigh-pressure mercury lamp that emits light containing R light, G light, and B light. The light source 10 may be another discharge-type light source different from an ultrahigh-pressure mercury lamp or may alternatively be a solid-state light source, such as an LED and a laser. A first optical integration lens 11 and a second optical integration lens 12 each have a plurality of arrayed lens elements. The first optical integration lens 11 divides a light flux from the light source 10 into a plurality of light fluxes. Each of the lens elements of the first optical integration lens 11 focuses the light flux from the light source 10 in the vicinity of the corresponding lens element of the second optical integration lens 12. The lens elements of the second optical integration lens 12, which cooperate with a superimposing lens 14, form images of the lens elements of the first optical, integration lens 11 on liquid crystal panels 18H, 18G, and 18B. The configuration described above allows the light from the light source 10 to illuminate entire display areas of the liquid crystal panels 18R, 18G, and 188 with substantially uniform brightness.

A polarization conversion element 13 converts the light from the second optical integration lens 12 into predetermined linearly polarized, light. The superimposing lens 14 superimposes the images of the lens elements of the first optical integration lens 11 having passed through the second optical integration, lens 12 on the display areas of the liquid crystal panels 18R, 18G, and 18B.

A first dichroic mirror 15 reflects R light and transmits G light and B light incident thereon from the superimposing lens 14. The R light reflected off the first dichroic mirror 15 travels along a reflection mirror 16 and a field lens 17R and impinges on the liquid crystal panel 18R, which is a light modulation device. The liquid crystal panel 18R modulates the R light in accordance with an image signal to form an R image.

A second dichroic mirror 21 reflects the G light and transmits the B light having passed through, the first dichroic mirror 15. The G light reflected off the second dichroic mirror 21 passes through a field lens 17G and impinges on the liquid crystal panel 18G, which is a light modulation device. The liquid crystal panel 18G modulates the G light in accordance with an image signal to form a G image. The B light having passed through the second dichroic mirror 21 travels along relay lenses 22 and 24, reflection mirrors 23 and 25, and a field lens 17B and impinges on the liquid crystal panel 18B, which is a light modulation device. The liquid crystal panel 18B modulates the B light in accordance with an image signal to form, a 3 image.

A cross dichroic prism 19, which is a light combining prism, combines the light fluxes modulated by the liquid crystal panels 18R, 186, and 18B into image light and directs the image light to a projection room lens 40.

The projection zoom lens 40 enlarges and projects the image light produced by the cross dichroic prism 19 that combines the light fluxes modulated toy the liquid crystal panels 18G, 18R, and 18B on a screen (not shown),

The circuit apparatus 80 includes an image processor 81 to which a video signal or any other external image signal is inputted, a display driver 82 that drives the liquid crystal panels 18G, 18R, and 18B provided in the optical system portion 50 based on outputs from the image processor 81, a lens driver 83 that operates drive mechanisms (not shown) provided in the projection scorn lens 40 to adjust the state of the projection zoom lens 40, and a main controller 88 that oversees and controls the operation of the circuit portions 81, 82 and 83 and other components.

The image processor 81 converts an inputted external image signal into color image signals containing grayscales and other parameters. The image processor 81 can also perform distortion correction, color correction, and a variety of other types of image processing on the external image signal.

The display driver 82 can operate the liquid crystal panels 18G, 18R, and 18B based on the image signals outputted from the image processor 81 to allow the liquid crystal panels 18G, 18R, and 18B to form images corresponding to the image signals or images corresponding to the image signals having undergone image processing.

The lens driver 83, which operates under the control of the main controller 88, can move part of the optical elements that form the projection zoom lens 40 along an optical axis OA as appropriate to change the magnification at which the projection zoom lens 40 projects an image on the screen. Further, the lens driver 83 can change the vertical position of an image projected on the screen by performing tilt adjustment that moves the entire projection zoom lens 40 in the vertical direction perpendicular to the optical axis OA.

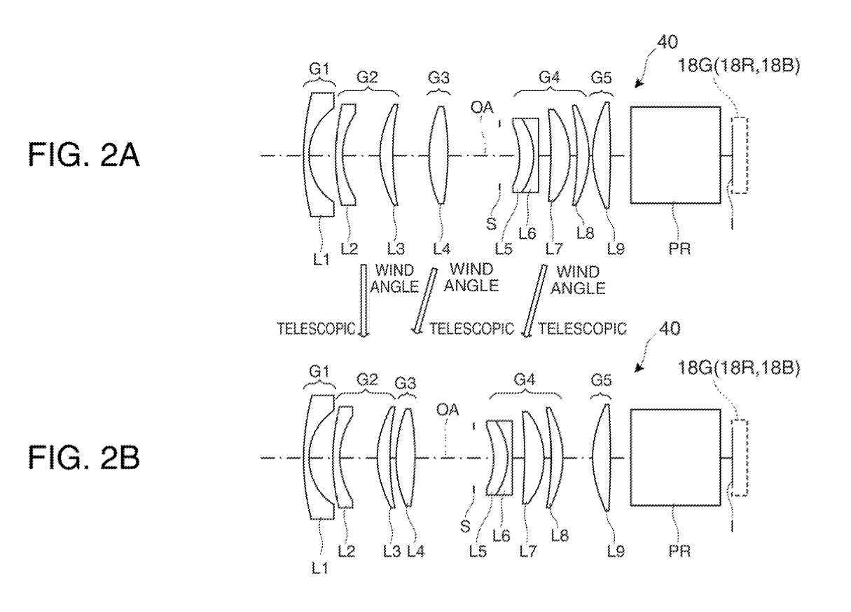

The projection zoom lens 40 according to the embodiment will be specifically described below with reference to FIGS. 2A and 2B and other figures. The projection zoom lens 40 illustrated in FIG. 2A and other figures has the same configuration as that of a projection zoom lens 40 according to Example 1, which will be described later.

The projection zoom lens 40 according to the embodiment is formed of the following lens groups sequentially arranged from the high magnification side: a first lens group G1 fixed at the time of zooming and having negative power; a second lens group G2; a third lens group G3; a fourth lens group G4; and a fifth lens group G5 fixed at the time of zooming and having positive power. The second, third, and fourth lens groups G2, G3, G4 are movable lens groups that are moved for rooming. The first lens group G1 is a front-end lens group disposed on the enlargement side, and the fifth lens group G5 is a rear-end lens group disposed on the reduction side.

The first lens group G1 includes, for example, only a single lens L1. The second lens group G2 includes, for example, two lenses L2 and L3. The third lens group G3 includes, for example, a single lens L4. The fourth lens group G4 includes, for example, a doublet formed of lenses L5 and L6 and two lenses L7 and L8. The fifth lens group G5 includes, for example, a single lens L9. The projection zoom lens 40 further includes an aperture stop S between the third lens group G3 and the fourth lens group G4.

In the thus configured projection zoom lens 40, at least two resin lenses having oppositely signed power factors are disposed in a lens group disposed on the high magnification side with respect to the aperture stop S. Specifically, the at least two resin lenses having oppositely signed power factors are, for example, the lens L2, which is a negative resin lens having negative power, and the lens L3, which is a positive resin lens having positive power, sequentially disposed from the high magnification side in the second lens group G2. Focus shifts produced by the thus configured pair of lenses L2 and L3 when the temperature changes cancel each other. The lenses L2 and L3 are disposed adjacent to each other in the same second lens group G2. Further, the lens L2, which is a negative resin lens on the high magnification side, has a steep concave surface facing the low magnification side, and the lens L3, which is a positive resin lens on the low magnification side, has a steep convex surface facing the high magnification side. The two resin lenses having oppositely signed power factors can alternatively be disposed on opposite sides of another lens in a single lens group or can still alternatively be disposed separately in a pair of lens groups disposed adjacent to each other.

As described above, when at least the two lenses L2 and L3, which are resin lenses having oppositely signed power factors, are disposed in positions that are not relatively far away from each other in a lens group on the high magnification side with respect to the aperture stop S, the difference in temperature between the lenses L2 audits can be reduced, whereby the amount of change in the focal point of the overall projection zoom lens 40 can be reduced. In the projection zoom lens 40, since light fluxes outputted from the liquid crystal panels 18R, 18G, and 18B are focused particularly in the vicinity of the aperture stop S, light that impinges on a lens frame or any other component in the vicinity of the aperture stop S generates heat, which increases the temperature of the lens groups on the low magnification side with respect to the aperture stop S (specifically, lens groups G4 and G5) in many oases. On the other hand, the lens groups on the high magnification side with respect to the aperture stop S (specifically, lens groups G1 to G3), which are closer to the atmosphere, experience a relatively small increase in temperature when in use. A resin lens, which is readily affected by an increase in temperature, is therefore preferably disposed on the high magnification side with respect to the stop, whereby the effect of the heat generated in the vicinity of the aperture stop S on the resin lens can be reduced. Disposing a resin lens (specifically, two lenses L2 and L3 having oppositely signed power factors), which is readily affected by an increase in temperature, on the high magnification side with respect to the aperture stop S can therefore reliably reduce the amount of focus shift due to variation in temperature.

The projection zoom lens 40 projects an image formed on a projected surface I of the liquid crystal panel 18G (18R, 18B) on the screen (not shown). A prism PR corresponding to the cross dichroic prism 19 shown in FIG. 1 is disposed between the projection zoom lens 40 and the liquid crystal panel 18G (18R, 18B).

A description will now be made of zooming. When a wide angle end state shown in FIG. 2A is changed to a telescopic end state shown in FIG. 2B, the third lens group G3, the fourth lens group G4 and other lens groups are moved along the optical axis OA toward the high magnification side. On the other hand, to bring a subject into focus, only the first lens group G1 is moved along the optical axis OA.

The projection zoom lens 40 satisfies the conditional expression (1) having been described above. That is, assuming that the lens L2, which is a negative resin lens disposed on the high magnification side, has a concave surface facing the low magnification side and having a radius of curvature Rn, and that the lens L3, which is a positive resin lens disposed on the low magnification side, has a convex surface facing the high magnification side and having a radius of curvature Rp, the following conditional expression is satisfied.

0.0<Rn/Rp<1.0 (1)

Consider a situation in which Rn/Rp is greater than the upper limit of the conditional expression (1) and the radius of curvature of the lens L2, which is a negative resin lens, is much greater than the radius of curvature of the lens L3, which is a positive resin lens. The situation is not preferable because it makes it difficult to suppress distortion and causes coma flare. Conversely, when Rn/Rp is smaller than the lower limit of the conditional expression (1) and the radius of curvature of the lens L2, which is a negative resin lens, is much smaller than the radius of curvature of the lens L3, which is a positive resin lens, the high-magnification-side surface of the positive resin lens has a concave shape, which makes it difficult to correct field curvature and astigmatism and it is hence difficult to produce a satisfactorily flat image plane.

The number of lens groups that form the projection zoom lens 40 is not limited to five but can be six or seven.

### EXAMPLES

Specific examples of the projection zoom lens 40 will be described below. The meanings of a variety of parameters common to Examples 1 to 6, which will be described below, are summarized as follows.

R Radius of curvature

D On-axis inter-surface distance (thickness of lens or distance between lenses)

nd Refractive index at d line

vd Abbe number at d line

dn/dt Temperature coefficient of refractive index

α Coefficient of linear expansion

Fno f-number

F Focal length of total system

ω Half angle of view

An aspheric surface is expressed by the following polynomial (expression of aspheric surface).

$$z = \frac{{ch}^{2}}{1 + \sqrt{1 - ( k + 1 ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12}$$

The parameters in the polynomial are as follows:

c Curvature (1/R)

h Height from, optical axis

k conical coefficient of aspheric surface

Ai higher-order aspheric coefficient of aspheric surface

### Example 1

Table 1 shown below summarises overall characteristics of a projection zoom lens according to Example 1. In Table 1, “Wide,” “Middle,” and “Tele” stand for the wide angle end, the middle position, and the telescopic end, respectively.

TABLE 1

| | Wide | Middle | Tele |
|---|---|---|---|
| FNo | 1.58 | 1.63 | 1.69 |
| F | 14.37 | 15.80 | 17.24 |
| ω | 30.5° | 27.9° | 25.9° |

Table 2 shown tee low shows data on the lens surfaces in Example 1. ST stands for the aperture stop S. A surface having a surface number followed by “*” is a surface having an aspheric shape.

TABLE 2

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 66.661 | 1.50 | 1.51633 | 64.1 | 1.5 | 73.0 |
| 2 | 15.710 | D2 | | | | |
| 3* | 63.354 | 2.00 | 1.53116 | 56.0 | −108.0 | 700.0 |
| 4* | 16.412 | D4 | | | | |
| 5* | 26.397 | 3.60 | 1.60737 | 27.0 | −108.0 | 700.0 |
| 6 | 75.599 | D6 | | | | |
| 7 | 33.612 | 5.50 | 1.51633 | 64.1 | 1.5 | 73.0 |
| 8 | −69.522 | D8 | | | | |
| ST | 1.00E+18 | 5.58 | | | | |
| 10* | −25.036 | 4.15 | 1.58913 | 61.1 | 2.5 | 57.7 |
| 11 | −16.786 | 1.20 | 1.84666 | 23.8 | 0.2 | 89.1 |
| 12 | 306.451 | 3.63 | | | | |
| 13 | −185.652 | 5.60 | 1.65844 | 50.9 | 3.1 | 69.0 |
| 14 | −20.366 | 2.10 | | | | |
| 15 | −68.197 | 3.40 | 1.51633 | 64.1 | 1.5 | 73.0 |
| 16 | −29.072 | D16 | | | | |
| 17 | 32.196 | 5.00 | 1.51633 | 64.1 | 1.5 | 73.0 |
| 18 | −236.950 | 6.00 | | | | |
| 19 | 1.00E+18 | 25.75 | 1.51680 | 64.2 | 2.3 | 73.0 |
| 20 | 1.00E+18 | 3.35 | | | | |

In Table 2 and the following tables, 10 raised to some power (1.00×10*¹⁸, for example) is expressed by using E (1.00E+18, for example).

Table 3 shown below shows aspheric coefficients of the lens surfaces in Example 1.

TABLE 3

Third surface
K = −1.0000, A04 = −9.9490E−07, A06 = 0.0000E+00,
A08 = 0.0000E+00, A10 = 0.0000E+00, A12 = 0.0000E+00
Fourth surface
K = 0.0000, A04 = −5.7861E−05, A06 = −1.4664E−07,
A08 = 4.4497E−10, A10 = −2.9370E−12, A12 = 0.0000E+00
Fifth surface
K = 0.0000, A04 = −1.2189E−05, A06 = −6.5361E−09,
A08 = 0.0000E+00, A10 = 0.0000E+00, A12 = 0.0000E+00
Tenth surface
K = 0.0000, A04 = −4.7803E−05, A06 = −1.2278E−07,
A08 = 2.3968E−10, A10 = 0.0000E+00, A12 = 0.0000E+00

Table 4 shown below shows variable distances D0, D2, D6, D8, and D16 in Table 2 at the wide angle end (Wide), the middle position (Middle), and the telescopic end. (Tele).

TABLE 4

| | Wide | Middle | Tele |
|---|---|---|---|
| D0 | 1800.00 | 1800.00 | 1800.00 |
| D2 | 7.62 | 6.69 | 6.85 |
| D6 | 10.29 | 6.09 | 1.50 |
| D8 | 14.78 | 16.32 | 17.05 |
| D16 | 1.00 | 4.33 | 8.27 |

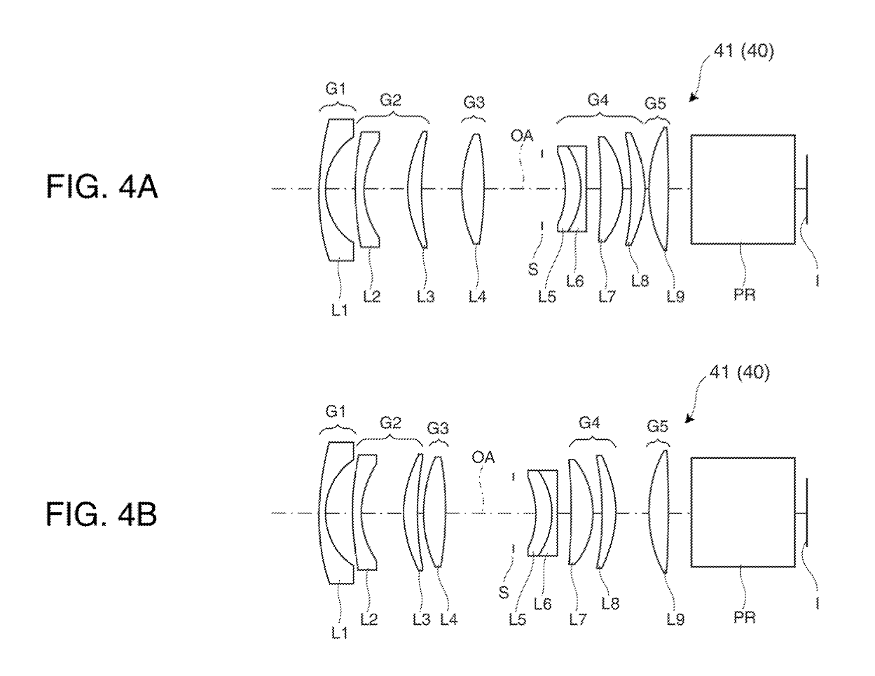

FIG. 4A is a cross-sectional view of the projection zoom lens according to Example 1 operating at the wide angle end, and FIG. 4B is a cross-sectional view of the projection zoom lens according to Example 1 operating at the telescopic end. The projection zoom lens, which enlarges and projects an image formed on each projected surface I at a variable magnification, includes a first lens group G1 having negative power, a second lens group G2 having negative power, a third lens group G3 having positive power, an aperture stop S, a fourth lens group G4 having positive power, and a fifth lens group G5 having positive power sequentially arranged from the high magnification side. To change the magnification, the first lens group G1 and the fifth lens group (rear-end lens group) G5 are fixed and the third lens group G3, the fourth lens group G4, and other lens groups, which are movable lens groups, are moved for zooming, and to bring a subject into focus, the first lens group G1 is moved for focusing,

The first lens group G1 includes a single lens, that is, a negative meniscus lens L1 having a convex surface facing the high magnification side. The second lens group G2 is formed of the following two lenses; a negative meniscus lens L2 having an aspheric surface on both sides one of which is a convex surface facing the high magnification side; and a positive meniscus lens L3 having an aspheric convex surface facing the high magnification side. The third lens group G3 includes a single lens, that is, a biconvex positive lens L4. The fourth lens group G4 is formed of the following four lenses; a doublet formed of a positive meniscus lens L5 having an aspheric concave surface facing the high magnification side and a biconcave negative lens L6; a positive meniscus lens L7 having a convex surface facing the low magnification side; and a positive meniscus lens L8 having a convex surface facing the low magnification side. The fifth lens group G5 includes a single lens, that is, a biconvex positive lens L9.

The negative meniscus lens L2 in the second lens group G2 and the positive meniscus lens L3 in the second lens group G2 are resin lenses, which means that two resin lenses having oppositely signed power factors are disposed adjacent to each other in the same lens group G2.

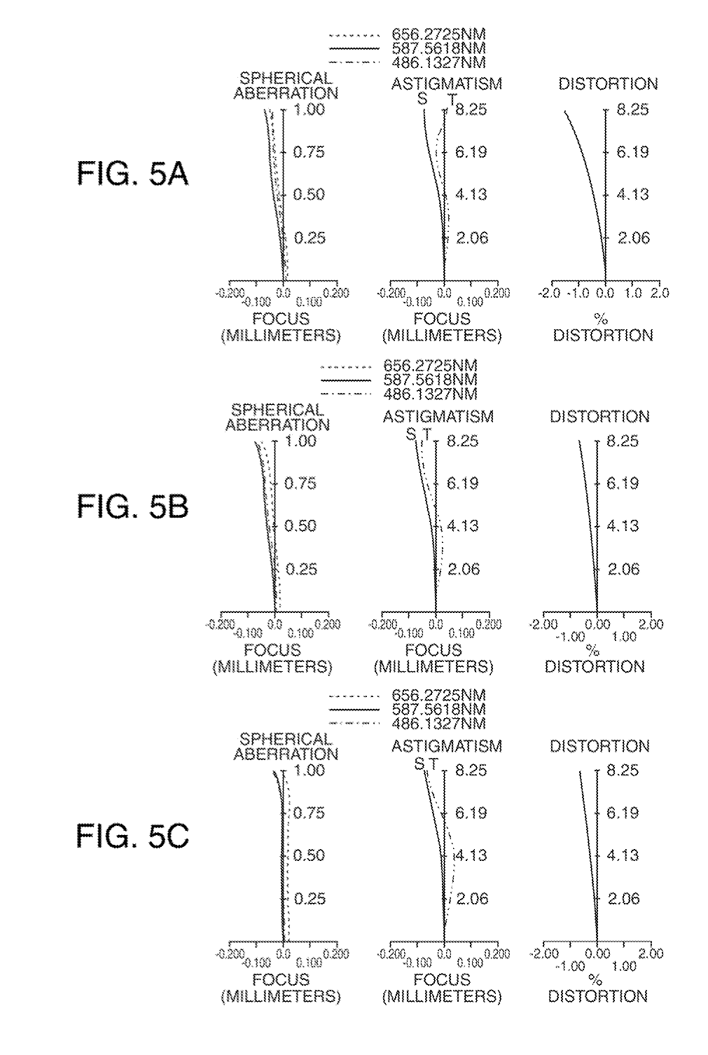

FIG. 5A shows aberrations (spherical aberration, astigmatism, and distortion) produced by the projection zoom lens 41 according to Example 1 operating at the wide angle end. FIG. 5B shows aberrations (spherical aberration, astigmatism, and distortion) produced by the projection zoom lens 41 according to Example 1 operating at the middle position. FIG. 5C shows aberrations (spherical aberration, astigmatism, and distortion) produced by the projection zoom lens 41 according to Example 1 operating at the telescopic end.

### Example 2

Table 5 shown below summarises overall characteristics of a projection zoom lens according to Example 2.

TABLE 5

| | Wide | Middle | Tele |
|---|---|---|---|
| FNo | 1.58 | 1.62 | 1.67 |
| F | 14.37 | 15.80 | 17.24 |
| ω | 30.3° | 27.9° | 25.9 |

Table 6 shown below shows data on the lens surfaces in Example 2.

TABLE 6

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 91.708 | 1.80 | 1.62299 | 58.2 | 0.8 | 65.9 |
| 2 | 17.276 | 3.78 | | | | |
| 3* | 25.000 | 2.20 | 1.53116 | 56.0 | −108.0 | 700.0 |
| 4* | 16.000 | D4 | | | | |
| 5 | 32.234 | 4.50 | 1.60737 | 27.0 | −108.0 | 700.0 |
| 6 | 196.599 | D6 | | | | |
| 7 | 37.080 | 8.00 | 1.72342 | 38.0 | 4.1 | 66.5 |
| 8 | −25.059 | 1.20 | 1.69895 | 30.1 | 2.5 | 76.0 |
| 9 | −6699.982 | D9 | | | | |
| ST | 1.00E+18 | 8.67 | | | | |
| 11 | −13.812 | 1.60 | 1.80518 | 25.4 | 0.1 | 90.3 |
| 12 | 227.276 | 0.83 | | | | |
| 13 | −56.724 | 4.00 | 1.58913 | 61.1 | 2.5 | 57.7 |
| 14* | −21.988 | 0.20 | | | | |
| 15 | 1058.401 | 7.00 | 1.51633 | 64.1 | 1.5 | 73.0 |
| 16 | −16.182 | D16 | | | | |
| 17 | 41.796 | 5.40 | 1.58913 | 61.1 | 2.5 | 57.7 |
| 18 | −76.492 | 6.00 | | | | |
| 19 | 1.00E+18 | 25.75 | 1.51633 | 64.1 | 1.5 | 73.0 |
| 20 | 1.00E+18 | 3.35 | | | | |

Table 7 shown below shows aspheric coefficients of the lens surfaces in Example 2.

TABLE 7

Third surface
K = 0.0000, A04 = −1.5916E−05, A06 = 0.0000E+00,
A08 = 0.0000E+00, A10 = 0.0000E+00, A12 = 0.0000E+00
Fourth surface
K = −0.8433, A04 = −2.8157E−05, A06 = −9.7003E−08,
A08 = 4.5963E−10, A10 = −1.5454E−12, A12 = 0.0000E+00
Fourteenth surface
K = 0.0000, A04 = 2.4951E−05, A06 = 1.1212E−07,
A08 = 1.9370E−10, A10 = 0.0000E+00, A12 = 0.0000E+00

Table 8 shown below shows variable distances D0, D4, D6, D9, and D16 in Table 6 at the wide angle end (Wide), the middle position (Middle), and the telescopic end (Tele).

TABLE 8

| | Wide | Middle | Tele |
|---|---|---|---|
| D0 | 1800.00 | 1800.00 | 1800.00 |
| D4 | 11.98 | 11.15 | 10.65 |
| D6 | 15.26 | 11.00 | 6.75 |
| D9 | 3.89 | 5.69 | 6.92 |
| D16 | 1.00 | 4.26 | 7.77 |

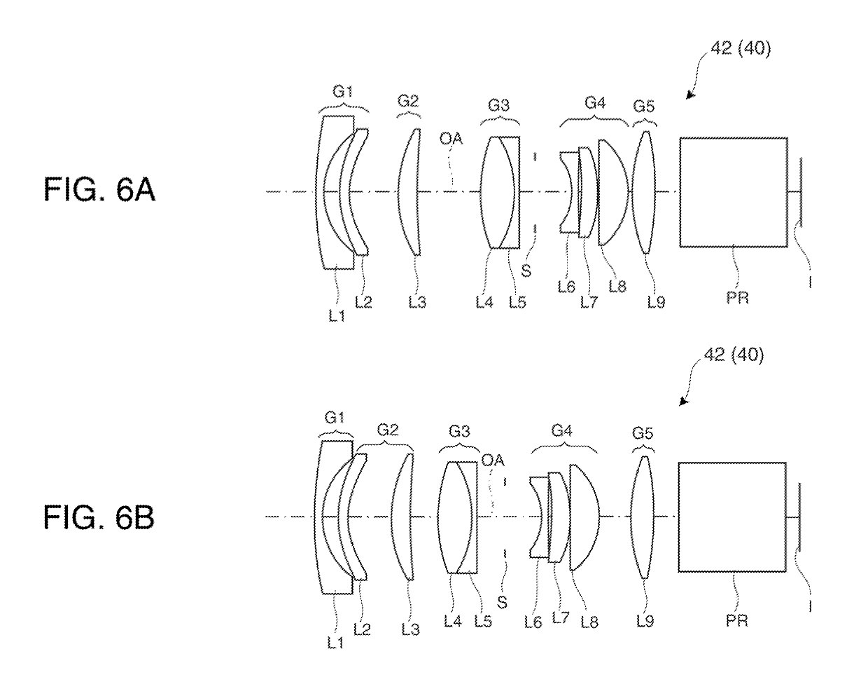

FIG. 6A is a cross-sectional view of the projection zoom lens 42 according to Example 2 operating at the wide angle end, and FIG. 6B is a cross-sectional view of the projection zoom lens 42 according to Example 2 operating at the telescopic end. The projection zoom lens 42, which enlarges and projects an image formed on each projected surface I at a variable magnification, includes a first lens group G1 having negative power, a second lens group G2 having positive power, a third lens group G3 having positive power, an aperture stop S, a fourth lens group G4 having positive power, and a fifth lens group G5 having positive power sequentially arranged from the high magnification side. To change the magnification, the first lens group G1 and the fifth lens group (rear-end lens group) G5 are fixed and the third lens group G0, the fourth lens group G4, and other lens groups, which are movable lens groups, are moved for zooming, and to bring a subject into focus, the first lens group G1 is moved for focusing.

The first lens group G1 is formed of the following two lenses: a negative meniscus lens L1 having a convex surface facing the high magnification side; and a negative meniscus lens L2 having an aspheric surface on both sides one of which is a convex surface facing the high magnification side. The second lens group G2 includes a single lens, that is, a positive meniscus lens L3 having a convex surface facing the high magnification side. The third lens group G3 is formed of the following two lenses: a doublet formed of a biconvex positive lens L4 and a negative meniscus lens L5 having a convex surface facing the low magnification side. The fourth lens group G4 is formed of the following three lenses: a biconcave negative lens L6; a positive meniscus lens L7 having an aspheric convex surface facing the low magnification side; and a biconvex positive lens L8. The fifth lens group G5 includes a single lens, that is, a biconvex positive lens L9.

The negative meniscus lens L2 in the first lens group G1 and the positive meniscus lens L3 in the second lens group G2 are resin lenses, which means that two resin lenses having oppositely signed power factors are disposed adjacent to each other in the lens groups G1 and G2 disposed adjacent to each other.

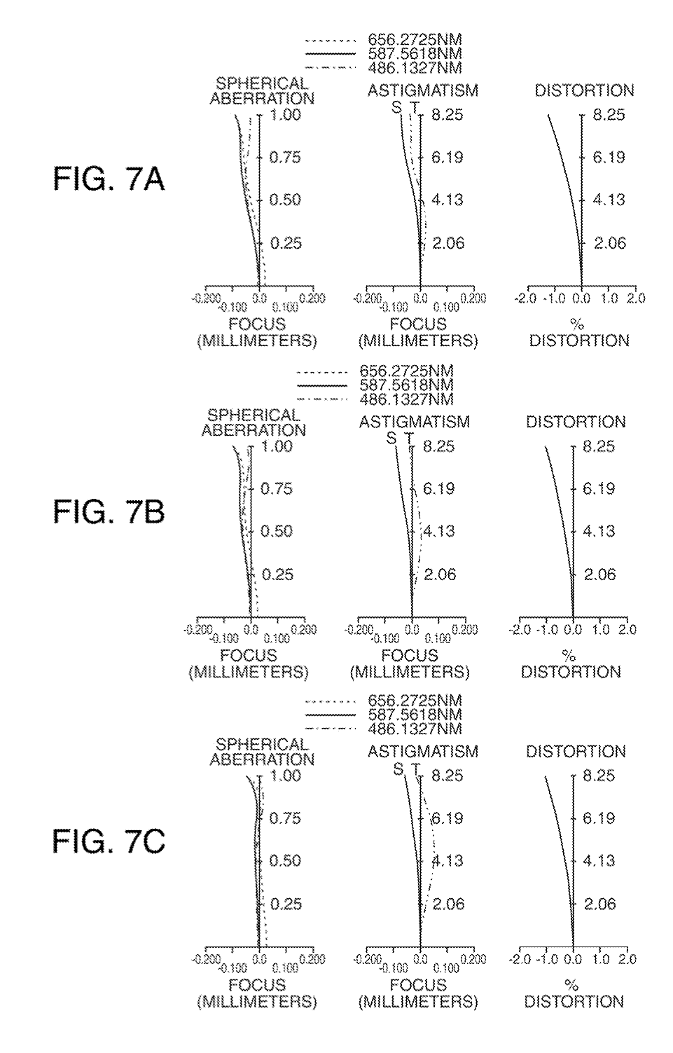

FIG. 1A shows aberrations (spherical aberration, astigmatism, and distortion) produced by the projection zoom lens 42 according to Example 2 operating an the wide angle end. FIG. 7B shows aberrations (spherical aberration, astigmatism, and distortion) produced by the projection zoom lens 42 according to Example 2 operating at the middle position. FIG. 7C shows aberrations (spherical aberration, astigmatism, and distortion) produced by the projection zoom lens 42 according to Example 2 operating at the telescopic end.

### Example 3

Table 9 shown below summarizes overall characteristics of a projection zoom lens according to Example 3.

TABLE 9

| | Wide | Middle | Tele |
|---|---|---|---|
| FNo | 1.49 | 1.73 | 2.01 |
| F | 13.83 | 17.94 | 22.19 |
| ω | 31.6° | 25.2° | 20.8° |

Table 10 shown below shows data on the lens surfaces in Example 3.

TABLE 10

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 1000.000 | 2.00 | 1.51633 | 64.1 | 1.5 | 73.0 |
| 2 | 26.388 | D2 | | | | |
| 3* | 38.298 | 3.00 | 1.53116 | 56.0 | −108.0 | 700.0 |
| 4* | 18.037 | D4 | | | | |
| 5* | 46.694 | 3.50 | 1.60737 | 27.0 | −108.0 | 700.0 |
| 6 | 107.516 | D6 | | | | |
| 7 | 36.813 | 4.92 | 1.7432 | 49.3 | 5.1 | 54.9 |
| 8 | −340.218 | D8 | | | | |
| ST | 1.00E+18 | 5.57 | | | | |
| 10 | −31.971 | 1.90 | 1.84666 | 23.8 | 0.2 | 89.1 |
| 11 | 37.694 | 6.22 | 1.58913 | 61.1 | 2.5 | 57.7 |
| 12* | −107.950 | 3.46 | | | | |
| 13 | −74.233 | 4.28 | 1.58913 | 61.1 | 2.5 | 57.7 |
| 14 | −22.807 | D14 | | | | |
| 15 | 33.873 | 5.20 | 1.58913 | 61.1 | 2.5 | 57.7 |
| 16 | −181.255 | 5.75 | | | | |
| 17 | 1.00E+18 | 25.75 | 1.51633 | 64.2 | 1.5 | 73.0 |
| 18 | 1.00E+18 | 3.00 | | | | |

Table 11 shown below shows aspheric coefficients of the lens surfaces in Example 3,

TABLE 11

Third surface
K = 0.0000, A04 = 2.0258E−05, A06 = −6.0588E−08,
A08 = 9.3752E−11, A10 = 0.0000E+00, A12 = 0.0000E+00
Fourth surface
K = 0.0000, A04 = −2.1790E−06, A06 = −8.6276E−08,
A08 = −2.3525E−10, A10 = 1.3339E−12, A12 = −3.3340E−15
Fifth surface
K = 0.0000, A04 = −1.8678E−06, A06 = −7.7625E−10,
A08 = 0.0000E+00, A10 = 0.0000E+00, A12 = 0.0000E+00
Twelfth surface
K = 7.3638, A04 = 1.8664E−05, A06 = 1.1791E−08,
A08 = −5.7228E−11, A10 = 0.0000E+00, A12 = 0.0000E+00

Table 12 shown below shows variable distances D0, D2, D4, D6, D8, and 014 in Table 10 at the wide angle end (Wide), the middle position (Middle), and the telescopic end (Tele),

TABLE 12

| | Wide | Middle | Tele |
|---|---|---|---|
| D0 | 1700.00 | 2200.00 | 2700.00 |
| D2 | 7.79 | 7.35 | 4.28 |
| D4 | 38.65 | 32.11 | 30.53 |
| D6 | 15.77 | 8.30 | 1.00 |
| D8 | 11.86 | 13.90 | 15.42 |
| D14 | 1.10 | 13.12 | 23.34 |

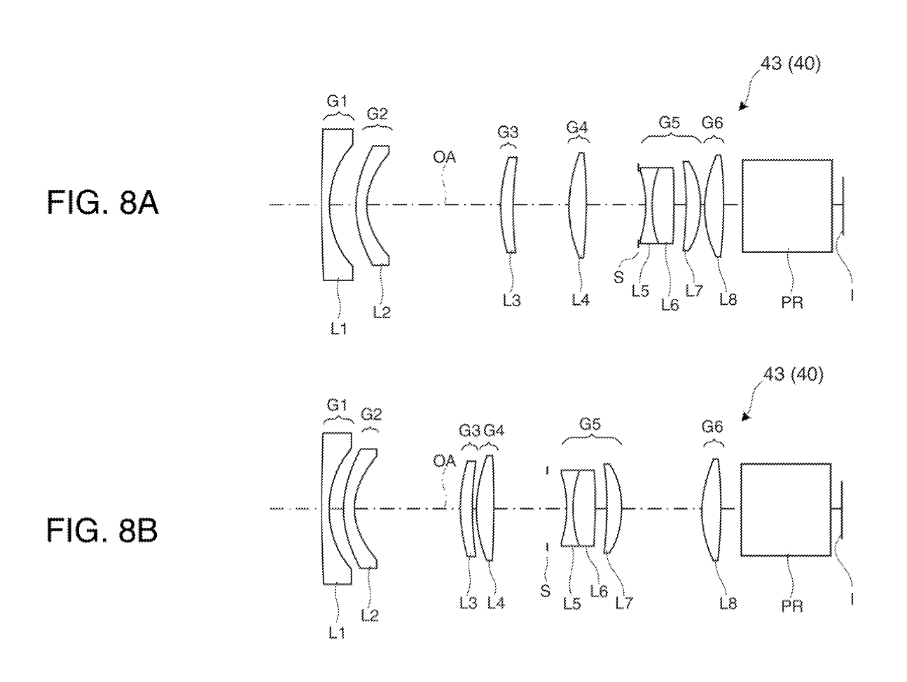

FIG. 8A is a cross-sectional view of the projection zoom lens 43 according to Example 3 operating at the wide angle end, and FIG. 8B is a cross-sectional view of the projection zoom lens 43 according to Example 3 operating at the telescopic end. The projection zoom lens 43, which enlarges and projects an image formed on each projected surface I at a variable magnification, includes a first lens group G1 having negative power, a second lens group G2 having negative power, a third lens group G3 having positive power, a fourth lens group G4 having positive power, an aperture stop S, a fifth lens group G5 having negative power, and a sixth lens group G6 having positive power sequentially arranged from the high magnification side. To change the magnification, the first lens group G1 and the sixth lens group (rear-end lens group) G6 are fixed and the fourth lens group G4, the fifth lens group G5, and other lens groups, which are movable lens groups, are moved for zooming, and to bring a subject into focus, the first lens group G1 is moved for focusing.

The first lens group G1 includes a single lens, that is, a negative meniscus lens L1 having a convex surface facing the high magnification side. The second lens group G2 includes a single lens, that is, a negative meniscus lens L2 having an aspheric surface on both sides one of which is a convex surface facing the high magnification side. The third lens group G3 includes a single lens, that is, a positive meniscus lens L3 having an aspheric convex surface facing the high magnification side. The fourth lens group G4 includes a single lens, that is, a biconvex positive lens L4. The fifth lens group G5 is formed of the following three lenses: a doublet formed of a biconcave negative lens L5 and a biconvex positive lens L6 having an aspheric surface facing the low magnification side; and a positive meniscus lens L7 having a convex surface facing the low magnification side. The sixth lens group G6 includes a single lens, that is, a biconvex positive lens L8.

The negative meniscus lens L2 in the second lens group G2 and the positive meniscus lens L3 in the third lens group G3 are resin lenses, which means that two resin lenses having oppositely signed power factors are disposed adjacent to each other in the lens groups G2 and G3 disposed adjacent to each other.

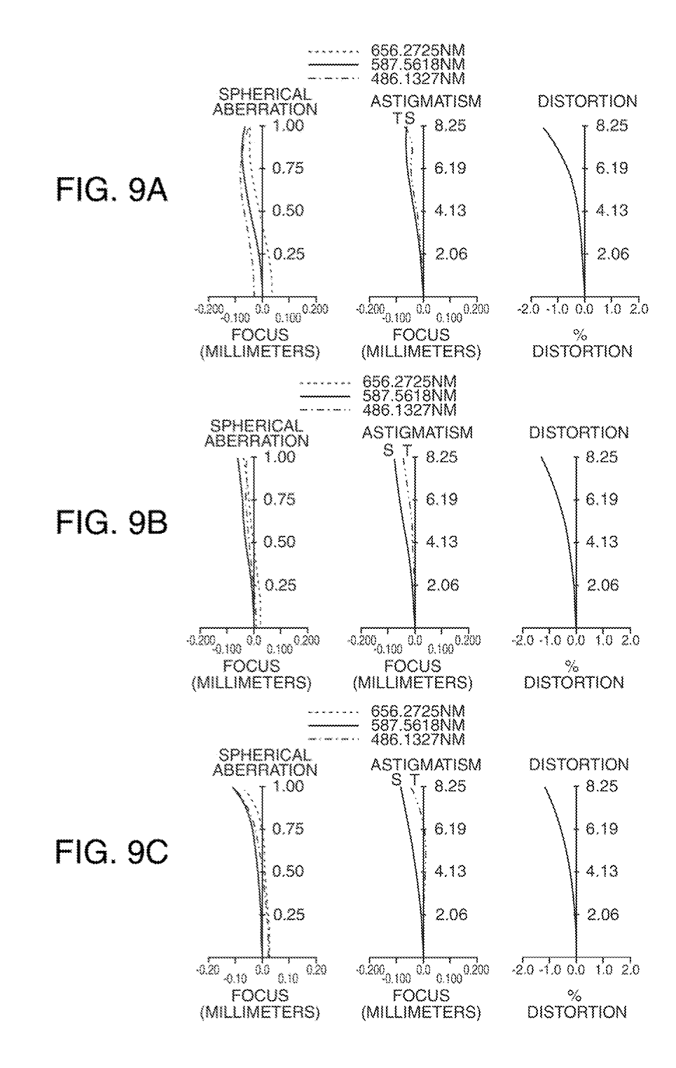

FIG. 9A shows aberrations (spherical aberration, astigmatism, and distortion) produced by the projection zoom lens 43 according to Example 3 operating at the wide angle end. FIG. 9B shows aberrations (spherical aberration, astigmatism, and distortion) produced by the projection zoom lens 43 according to Example 3 operating at the middle position. FIG. 9G shows aberrations (spherical aberration, astigmatism, and distortion) produced by the projection zoom lens 43 according to Example 3 operating at the telescopic end.

### Example 4

Table 13 shown below summarizes overall characteristics of a projection zoom lens according to Example 4.

TABLE 13

| | Wide | Middle | Tele |
|---|---|---|---|
| FNo | 1.56 | 1.77 | 1.99 |
| F | 15.83 | 20.53 | 25.40 |
| ω | 31.1° | 25.1° | 20.9° |

Table 14 shown below shows data on the lens surfaces in Example 4.

TABLE 14

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 80.275 | 2.00 | 1.65844 | 50.9 | 4.3 | 69.0 |
| 2 | 23.140 | D2 | | | | |
| 3* | 36.690 | 3.00 | 1.53116 | 56.0 | −108.0 | 700.0 |
| 4* | 22.058 | 17.17 | | | | |
| 5 | −25.566 | 2.00 | 1.69680 | 55.5 | 4.1 | 58.0 |
| 6 | −42.483 | 0.10 | | | | |
| 7 | 185.266 | 3.50 | 1.60737 | 27.0 | −108.0 | 700.0 |
| 8* | −98.247 | D8 | | | | |
| 9 | 28.585 | 5.00 | 1.65844 | 50.9 | 4.3 | 69.0 |
| 10 | −376.982 | D10 | | | | |
| ST | 1.000E+18 | 0.00 | | | | |
| 12 | 27.920 | 3.80 | 1.72342 | 38.0 | 5.2 | 66.5 |
| 13 | 111.207 | D13 | | | | |
| 14 | −72.062 | 1.50 | 1.80518 | 25.4 | 0.1 | 90.3 |
| 15 | 36.401 | 3.58 | | | | |
| 16 | −17.819 | 2.00 | 1.64769 | 33.8 | 1.2 | 84.1 |
| 17 | 24.528 | 4.80 | 1.58642 | 60.8 | 4.6 | 66.0 |
| 18* | −78.564 | 0.10 | | | | |
| 19 | 83.865 | 6.40 | 1.58913 | 61.1 | 2.5 | 57.7 |
| 20 | −20.946 | D20 | | | | |
| 21 | 37.168 | 5.20 | 1.51633 | 64.1 | 1.5 | 73.0 |
| 22 | −135.890 | 5.75 | | | | |
| 23 | 1.00E+18 | 25.75 | 1.51633 | 64.1 | 1.5 | 73.0 |
| 24 | 1.00E+18 | 3.00 | | | | |

Table 15 shown below shows aspheric coefficients of the lens surfaces in Example 4.

TABLE 15

Third surface
K = 2.3379, A04 = −1.1365E−06, A06 = 0.0000E+00,
A08 = 0.0000E+00, A10 = 0.0000E+00, A12 = 0.0000E+00
Fourth surface
K = 0.0000, A04 = −1.6397E−05, A06 = −1.4618E−08,
A08 = 2.6093E−12, A10 = −3.6300E−14, A12 = −2.9100E−17
Eighth surface
K = −5.6842, A04 = 2.4757E−06, A06 = 1.2638E−09,
A08 = 1.4347E−11, A10 = 0.0000E+00, A12 = 0.0000E+00
Eighteenth surface
K = 0.0000, A04 = 2.9735E−05, A06 = 1.4967E−08,
A08 = 4.2471E−11, A10 = −6.3983E−13, A12 = 0.0000E+00

Table 16 shown below shows variable distances D0, D2, D8, DID, D13, and D20 in Table 14 at the wide angle end (Wide), the middle position (Riddle), and the telescopic end (Tele).

TABLE 16

| | Wide | Middle | Tele |
|---|---|---|---|
| D0 | 1700.00 | 2200.00 | 2700.00 |
| D2 | 5.45 | 7.38 | 4.80 |
| D8 | 21.58 | 7.66 | 1.00 |
| D10 | 11.70 | 11.42 | 10.65 |
| D13 | 1.97 | 2.87 | 4.00 |
| D20 | 1.10 | 12.03 | 20.70 |

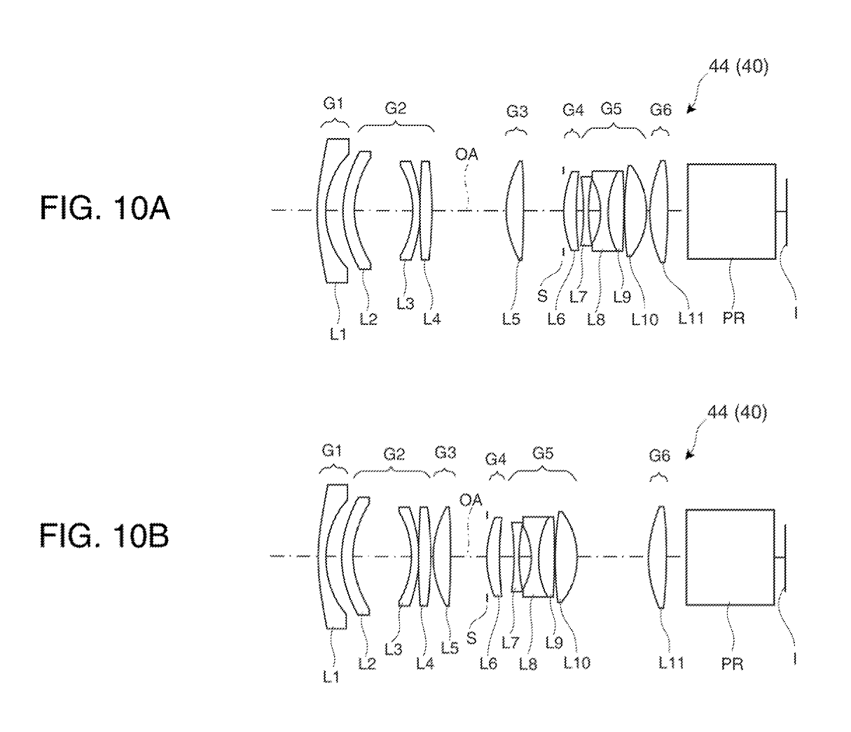

FIG. 10 ft is a cross-sectional view of the projection zoom lens 44 according to Example 4 operating at the wide angle end, and FIG. 10B is a cross-sectional view of the projection zoom lens 44 according to Example 4 operating at the telescopic end. The projection zoom lens 44, which enlarges and projects an image formed on each projected surface I at a variable magnification, includes a first lens group G1 having negative power, a second lens group G2 having negative power, a third lens group G3 having positive power, an aperture stop S, a fourth lens group G4 having positive power, a fifth lens group G5 having negative power, and a sixth lens group G6 having positive power sequentially arranged from the high magnification side. To change the magnification, the first lens group G1 and the sixth lens group (rear-end lens group) G6 are fixed and the fifth lens group G5, the fourth lens group G4, and other lens groups, which are movable lens groups, are moved for zooming, and to bring a subject into focus, the first lens group G1 is moved for focusing.

The first lens group G1 includes a single lens, that is, a single negative meniscus lens having a convex surface facing the high magnification side. The second lens group G2 is formed of the following three lenses: a negative meniscus lens L2 having an aspheric surface on both sides one of which is a; convex surface facing the high magnification side; a negative meniscus lens L3 having a convex surface facing the low magnification side; and a biconvex positive lens L4 having an aspheric surface facing the low magnification side. The third, lens group G3 includes a single lens, that is, a biconvex positive lens L5. The fourth lens group G4 includes a single lens, that is, a positive meniscus lens L6 having a convex surface facing the high magnification side. The fifth lens group G5 is formed of the following four lenses: a biconcave negative lens L7; a doublet formed of a biconcave negative lens L8 and a biconvex positive lens L9 having an aspheric surface facing the low magnification side; and a biconvex positive lens L10. The sixth lens group G6 includes a single lens, that is, a biconvex, positive lens L11.

The negative meniscus lens L2 in the second lens group G2 and the biconvex positive lens L4 in the second lens group G2 are resin lenses, which means that two resin lenses having oppositely signed power factors are disposed on opposite sides of the lens L3, which is another lens, in the same lens group G2.

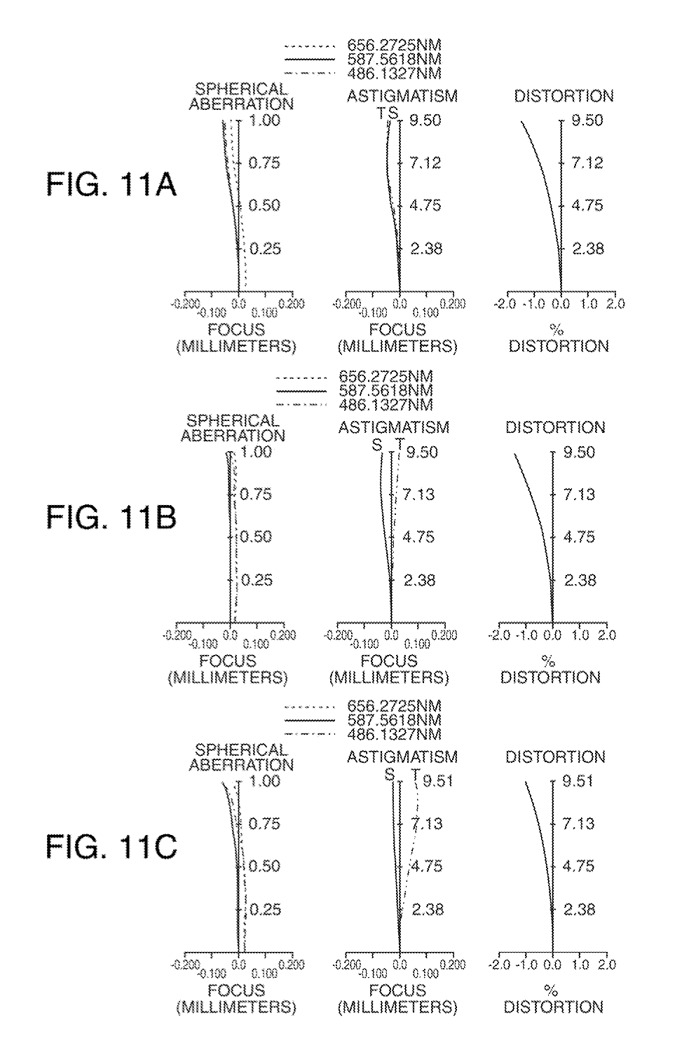

FIG. 11A shows aberrations (spherical aberration, astigmatism, and distortion) produced by the projection zoom lens 44 according to Example 4 operating at the wide angle end. FIG. 11B shows aberrations (spherical aberration, astigmatism, and distortion) produced by the projection zoom lens 44 according to Example 4 operating at the middle position. FIG. 11C shows aberrations (spherical, aberration, astigmatism, and distortion) produced by the projection zoom lens 44 according to Example 4 operating at the telescopic end.

### Example 5

Table 17 shown below summarises overall characteristics of a projection zoom lens according to Example 5.

TABLE 17

| | Wide | Middle | Tele |
|---|---|---|---|
| FNo | 1.48 | 1.65 | 1.83 |
| F | 15.83 | 20.53 | 25.40 |
| ω | 31.4° | 25.2° | 20.8° |

Table 18 shown below shows data on the lens surfaces in Example 5.

TABLE 18

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 50.000 | 2.00 | 1.51633 | 64.1 | 1.5 | 73.0 |
| 2 | 24.712 | 7.14 | | | | |
| 3 | 266.336 | 2.00 | 1.51633 | 64.1 | 1.5 | 73.0 |
| 4 | 23.303 | 1.00 | | | | |
| 5* | 26.428 | 3.50 | 1.53116 | 56.0 | −108.0 | 700.0 |
| 6* | 22.464 | D6 | | | | |
| 7 | 66.862 | 4.00 | 1.60737 | 27.0 | −108.0 | 700.0 |
| 8 | 824.637 | D8 | | | | |
| 9 | 42.468 | 5.00 | 1.65844 | 50.9 | 3.1 | 69.0 |
| 10 | −560.887 | D10 | | | | |
| 11 | 27.310 | 4.60 | 1.72342 | 38.0 | 4.1 | 66.5 |
| 12 | 1.00E+18 | D12 | | | | |
| ST | 1.00E+18 | 0.50 | | | | |
| 14 | −222.811 | 1.50 | 1.80518 | 25.4 | 0.1 | 90.3 |
| 15 | 23.880 | D15 | | | | |
| 16 | −22.915 | 1.30 | 1.64769 | 33.8 | 1.2 | 84.1 |
| 17 | 31.647 | 5.00 | 1.58642 | 60.8 | 4.6 | 66.0 |
| 18* | −44.657 | 2.99 | | | | |
| 19 | 465.947 | 6.20 | 1.51633 | 64.1 | 1.5 | 73.0 |
| 20 | −23.122 | D20 | | | | |
| 21 | 34.381 | 6.50 | 1.51633 | 64.1 | 1.5 | 73.0 |
| 22 | −204.359 | 5.75 | | | | |
| 23 | 1.00E+18 | 25.75 | 1.51633 | 64.2 | 1.5 | 73.0 |
| 24 | 1.00E+18 | 3.00 | | | | |

Table 19 shown below shows aspheric coefficients of the lens surfaces in Example 5.

TABLE 19

Fifth surface
K = −0.9768, A04 = 1.3129E−05, A06 = 0.0000E+00,
A08 = 0.0000E+00, A10 = 0.0000E+00, A12 = 0.0000E+00
Sixth surface
K = 0.0000, A04 = −9.1589E−06, A06 = −2.3518E−08,
A08 = −3.1564E−11, A10 = −3.6300E−14, A12 = −2.9100E−17
Eighteenth surface
K = 0.0000, A04 = 1.6158E−05, A06 = 2.9840E−08,
A08 = −3.0951E−11, A10 = 0.0000E+00, A12 = 0.0000E+00

Table 20 shown below shows variable distances D0, D6, D8, D10, D12, D15, and D20 in Table 18 at the wide angle end (Wide), the middle position (Middle), and the telescopic end (Tele).

TABLE 20

| | Wide | Middle | Tele |
|---|---|---|---|
| D0 | 1700.00 | 2200.00 | 2700.00 |
| D6 | 25.43 | 14.22 | 10.24 |
| D8 | 17.29 | 16.95 | 11.47 |
| D10 | 6.66 | 8.20 | 7.61 |
| D12 | 1.50 | 2.80 | 3.99 |
| D15 | 8.94 | 6.10 | 5.50 |
| D20 | 1.10 | 12.52 | 21.90 |

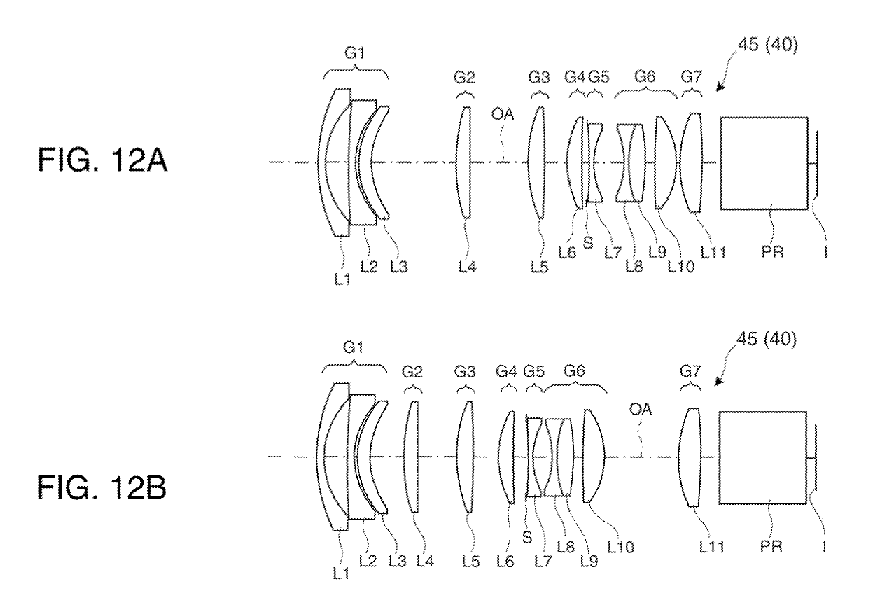

FIG. 12A is a cross-sectional view of the projection zoom lens 45 according to Example 5 operating at the wide angle end, and FIG. 12B is a cross-sectional view of the projection zoom lens 45 according to Example 5 operating at the telescopic end. The projection zoom lens 45, which enlarges and projects an image formed on each projected surface I at a variable magnification, includes a first lens group G1 having negative power, a second lens group G2 having positive power, a third lens group G3 having positive power, a fourth lens group G4 having positive power, an aperture stop S, a fifth lens group G5 having negative power, a sixth lens group G6 having positive power, and a seventh lens group G7 having positive power sequentially arranged from the high magnification side. To change the magnification, the first lens group G1 and the seventh lens group (rear-end lens group) G1 are fixed and the third lens group G3, the fourth lens group QA, and other lens groups, which are movable lens groups, are moved for zooming, and to bring a subject into focus, the first lens group G1 is moved for focusing.

The first lens group G1 includes the following three lenses; a negative meniscus lens L1 having a convex surface facing the high magnification side; a negative meniscus lens L2 having a convex surface facing the high magnification side; and a negative meniscus ions L3 having an aspheric surface on both sides one of which is a convex surface facing the high magnification side. The second lens group G2 includes a single lens, that is, a positive meniscus lens L4 having a convex surface facing the high magnification side. The third lens group G3 includes a single lens, that is, a biconvex positive lens L5. The fourth lens group G4 includes a single lens, that is, a plano-convex lens L6 having a convex surface facing the object side. The fifth lens group G5 includes a single lens, that is, a biconcave negative lens L7. The sixth lens group G6 includes the following three lenses: a doublet formed of a biconcave negative lens L8 and a biconvex positive lens L9 having an aspheric surface facing the low magnification side; and a biconvex positive lens L10. The seventh lens group G7 includes a single lens, that is, a biconvex positive lens L11.

The negative meniscus lens L3 in the first lens group G1 and the positive meniscus lens L4 in the second lens group G2 are resin lenses, which means that two resin lenses having oppositely signed power factors are disposed adjacent to each other in the lens groups G2 and G3 disposed adjacent to each other.

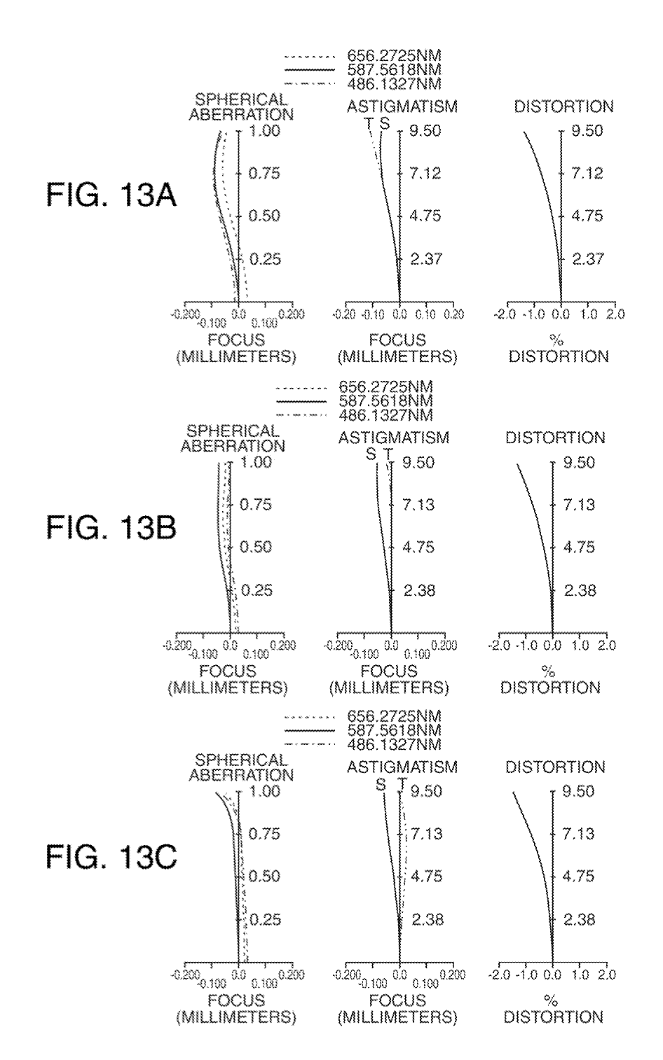

FIG. 13A shows aberrations (spherical aberration, astigmatism, and distortion) produced by the projection zoom lens 45 according to Example 5 operating at the wide angle end. FIG. 13B shows aberrations (spherical aberration, astigmatism, and distortion) produced by the projection zoom lens 45 according to Example 5 operating at the middle position. FIG. 13C shows aberrations (spherical aberration, astigmatism, and distortion) produced by the projection zoom lens 45 according to Example 5 operating at the telescopic end.

### Example 6

Table 21 shown below summarises overall characteristics of a projection zoom lens according to Example 6.

TABLE 21

| | Wide | Middle | Tele |
|---|---|---|---|
| FNo | 1.49 | 1.66 | 1.85 |
| F | 15.79 | 20.53 | 25.36 |
| ω | 31.4° | 25.2° | 20.8° |

Table 22 shown below shows data on the lens surfaces in Example 6.

TABLE 22

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 43.549 | 2.00 | 1.51633 | 64.1 | 1.5 | 73.0 |
| 2 | 25.492 | 4.78 | | | | |
| 3* | 52.100 | 3.00 | 1.53116 | 56.0 | −108.0 | 700.0 |
| 4* | 21.244 | 6.21 | | | | |
| 5 | −294.542 | 2.00 | 1.51633 | 64.1 | 1.5 | 73.0 |
| 6 | 39.959 | D6 | | | | |
| 7 | 102.420 | 4.00 | 1.60737 | 27.0 | −108.0 | 700.0 |
| 8 | −195.583 | D8 | | | | |
| 9 | 44.690 | 5.00 | 1.65844 | 50.9 | 3.1 | 69.0 |
| 10 | −514.733 | D10 | | | | |
| 11 | 25.023 | 4.60 | 1.72342 | 38.0 | 4.1 | 66.5 |
| 12 | 1.00E+18 | D12 | | | | |
| ST | 1.00E+18 | 0.50 | | | | |
| 14 | −334.935 | 1.50 | 1.80518 | 25.4 | 0.1 | 90.3 |
| 15 | 22.350 | D15 | | | | |
| 16 | −24.715 | 1.30 | 1.64769 | 33.8 | 1.2 | 84.1 |
| 17 | 20.973 | 6.00 | 1.58642 | 60.8 | 4.6 | 66.0 |
| 18 | −46.955 | 5.68 | | | | |
| 19* | 133.944 | 6.20 | 1.51633 | 64.1 | 1.5 | 73.0 |
| 20 | −24.812 | D20 | | | | |
| 21 | 33.779 | 5.20 | 1.51633 | 64.1 | 1.5 | 73.0 |
| 22 | −433.495 | 5.75 | | | | |
| 23 | 1.00E+18 | 25.75 | 1.51633 | 64.1 | 1.5 | 73.0 |
| 24 | 1.00E+18 | 3.00 | | | | |

Table 23 shown below shows aspheric coefficients of the lens surfaces in Example 6.

TABLE 23

Third surface
K = −0.8150, A04 = −2.2642E−06, A06 = 0.0000E+00,
A08 = 0.0000E+00, A10 = 0.00E+00, A12 = 0.00E+00
Fourth surface
K = 0.0000, A04 = −1.5751E−05, A06 = −1.8148E−08,
A08 = −3.1356E−11, A10 = −3.6300E−14, A12 = −2.9100E−17
Nineteenth surface
K = 0.0000, A04 = 1.6626E−05, A06 = 3.2367E−08,
A08 = 8.1904E−12, A10 = 0.0000E+00, A12 = 0.0000E+00

Table 24 shown below shows variable distances D0, D6, D8, D10, D12, D15, and D20 in Table 22 at the wide angle end (Wide), the middle position (Middle), and the telescopic end (Tele).

TABLE 24

| | Wide | Middle | Tele |
|---|---|---|---|
| D0 | 1700.00 | 2200.00 | 2700.00 |
| D6 | 21.82 | 12.84 | 10.20 |
| D8 | 11.07 | 7.82 | 0.90 |
| D10 | 7.97 | 12.46 | 12.62 |
| D12 | 1.50 | 2.75 | 3.98 |
| D15 | 12.63 | 6.89 | 5.50 |
| D20 | 1.10 | 13.24 | 22.74 |

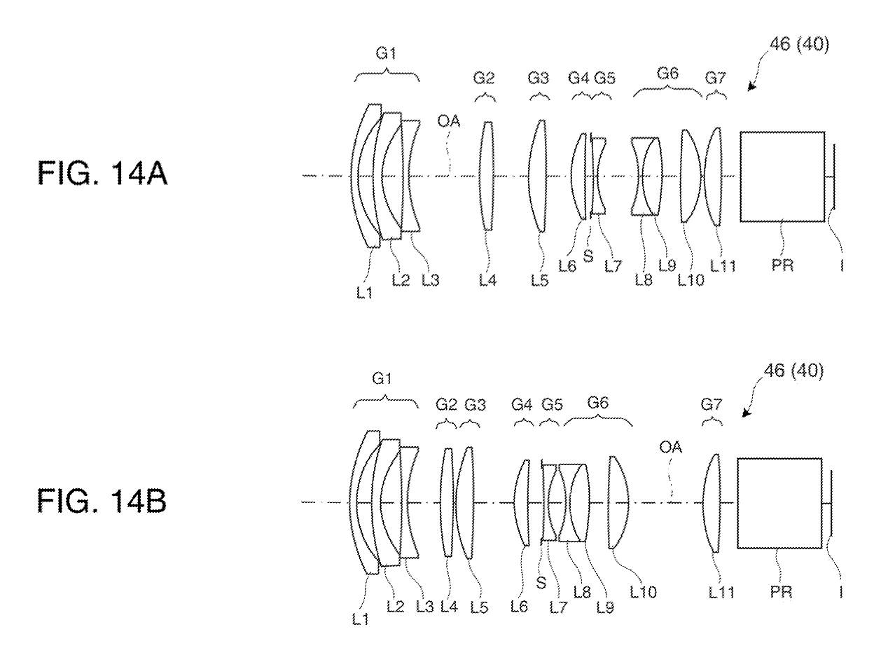

FIG. 14A is a cross-sectional view of the projection zoom lens 46 according to Example 6 operating at the wide angle end, and FIG. 14B is a cross-sectional view of the projection zoom lens 46 according to Example 6 operating at the telescopic end. The projection zoom lens 46, which enlarges and projects an image formed on each projected surface I at a variable magnification, includes a first lens group G1 having negative power, a second lens group G2 having positive power, a third lens group G3 having positive power, a fourth lens group G4 having positive power, an aperture stop S, a fifth lens group G5 having negative power, a sixth lens group G6 having positive power, and a seventh lens group G1 having positive power sequentially arranged from the high magnification side. To change the magnification, the first lens group G1 and the seventh lens group (rear-end lens group) G7 are fixed and the fifth lens group G5, the sixth lens group G6, and other lens groups, which are movable lens groups, are moved for zooming, and to bring a subject into focus, the first lens group G1 is moved for focusing.

The first lens group G1 includes the following three lenses; a negative meniscus lens L1 having a convex surface facing the high magnification side; a negative meniscus lens L2 having an aspheric surface on both sides one of which is a convex surface facing the high magnification side; and a biconcave negative lens L3. The second lens group G2 includes a single lens, that is, a biconvex positive lens L4. The third lens group G3 includes a single lens, that is, a biconvex positive lens L5. The fourth lens group G4 includes a single lens, that is, a plano-convex lens L6 having a convex surface facing the object side. The fifth tens group G5 includes a single lens, that is, a biconcave negative lens L7. The sixth lens group G6 includes the following three lenses: a doublet formed of a biconcave negative lens L3 and a biconvex positive lens L9; and a biconvex positive lens L10 having an aspheric surface facing the high magnification, side. The seventh lens group G7 includes a single lens, that is, a biconvex positive lens L11.

The negative meniscus lens L2 in the first lens group G1 and the biconvex positive lens L4 in the second lens group G1 are resin lenses, which means that two resin lenses having oppositely signed power factors are disposed on opposite sides of the lens L3, which is another lens, in the lens groups G1 and 62 disposed adjacent to each other.

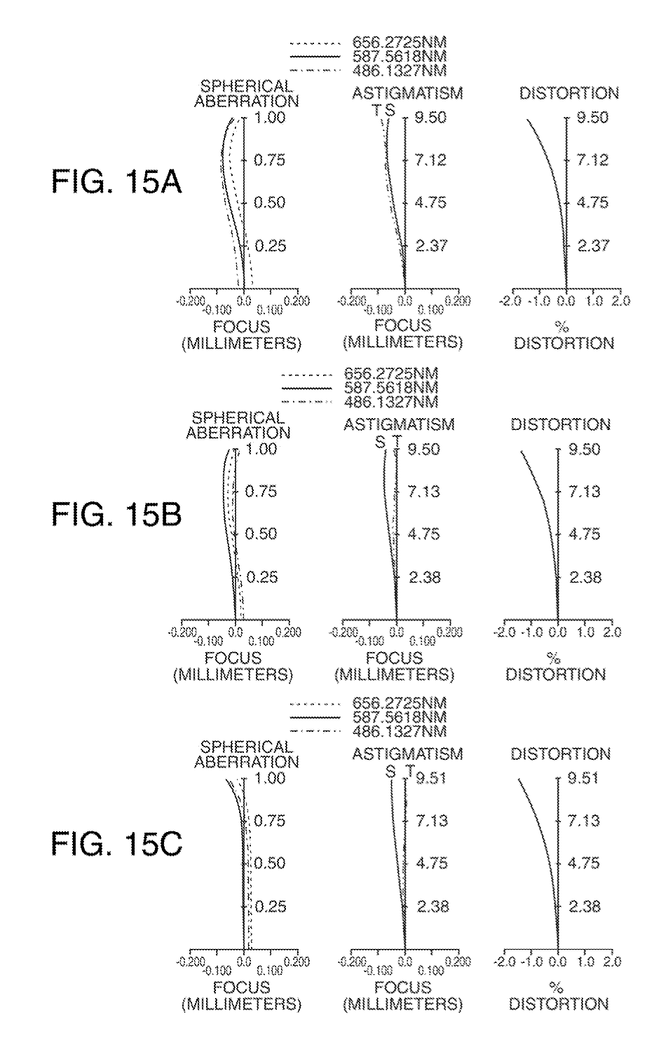

FIG. 15A shows aberrations (spherical aberration, astigmatism, and distortion) produced by the projection zoom lens 46 according to Example 6 operating at the wide angle end. FIG. 15E shows aberrations (spherical aberration, astigmatism, and distortion) produced by the projection zoom lens 46 according to Example 6 operating at the middle position. FIG. 15C shows aberrations (spherical aberration, astigmatism, and distortion) produced by the projection zoom lens 46 according to Example 6 operating at the telescopic end.

### Reference Example

Table 25 shown below summarises overall characteristics of a projection zoom lens according to Reference Example.

TABLE 25

| | Wide | Middle | Tele |
|---|---|---|---|
| FNo | 1.58 | 1.64 | 1.70 |
| F | 14.37 | 15.80 | 17.24 |
| ω | 30.5° | 28.1° | 26.2° |

Table 2 6 shown below shows data on the lens surfaces in Reference Example.

TABLE 26

| Surface | | | | | dn/ | |
|---|---|---|---|---|---|---|
| number | R | D | nd | vd | dt(×10⁻⁶) | α(×10⁻⁷) |
| 0 | | D0 | | | | |
| 1 | 63.286 | 1.50 | 1.51633 | 64.1 | 1.5 | 73.0 |
| 2 | 17.588 | D2 | | | | |
| 3* | 64.947 | 2.00 | 1.53116 | 56.0 | −108.0 | 700.0 |
| 4* | 16.122 | 14.37 | | | | |
| 5 | 47.467 | 3.20 | 1.80518 | 25.4 | 0.1 | 90.3 |
| 6 | 185.065 | D6 | | | | |
| 7 | 42.687 | 3.60 | 1.72000 | 50.2 | 5.4 | 61.0 |
| 8 | −121.438 | D8 | | | | |
| ST | 1.00E+18 | 5.58 | | | | |
| 10 | −22.300 | 3.50 | 1.51633 | 64.1 | 1.5 | 73.0 |
| 11 | −17.476 | 1.20 | 1.84666 | 23.8 | 0.2 | 89.1 |
| 12 | 282.531 | 3.57 | | | | |
| 13 | 52.195 | 5.20 | 1.58913 | 61.1 | 2.5 | 57.7 |
| 14 | −29.560 | 5.29 | | | | |
| 15* | −837.657 | 3.40 | 1.53116 | 56.0 | −108.0 | 700.0 |
| 16* | −47.831 | D16 | | | | |
| 17 | 33.336 | 4.60 | 1.51633 | 64.1 | 1.5 | 73.0 |
| 18 | −116.582 | 6.00 | | | | |
| 19 | 1.00E+18 | 25.75 | 1.51680 | 64.2 | 2.3 | 73.0 |
| 20 | 1.00E+18 | 3.35 | | | | |

Table 27 shown below shows aspheric coefficients of the lens surfaces in Reference Example.

TABLE 27

Third surface
K = −1.0000, A04 = 3.4529E−06, A06 = −2.1519E−09,
A08 = 0.0000E+00, A10 = 0.0000E+00, A12 = 0.0000E+00
Fourth surface
K = 0.0000, A04 = −4.2637E−05, A06 = −1.3813E−07,
A08 = 3.0798E−10, A10 = −2.3358E−12, A12 = 0.0000E+00
Fifteenth surface
K = −1.0000, A04 = 9.1030E−06, A06 = 9.7872E−08,
A08 = 8.6880E−11, A10 = −3.0883E−13, A12 = 0.0000E+00
Sixteenth surface
K = −20.2023, A04 = 1.1758E−06, A06 = 1.7790E−07,
A08 = 0.0000E+00, A10 = 0.0000E+00, A12 = 0.0000E+00

Table 28 shown below shows variable distances D0, D2, D6, D8, and D16 in Table 26 at the wide angle end (Wide), the middle position (Middle), and the telescopic end (Tele).

TABLE 28

| | Wide | Middle | Tele |
|---|---|---|---|
| D0 | 1800.00 | 1800.00 | 1800.00 |
| D2 | 7.41 | 7.64 | 7.33 |
| D6 | 10.91 | 5.36 | 1.50 |
| D8 | 12.04 | 13.08 | 13.80 |
| D16 | 1.00 | 4.95 | 8.69 |

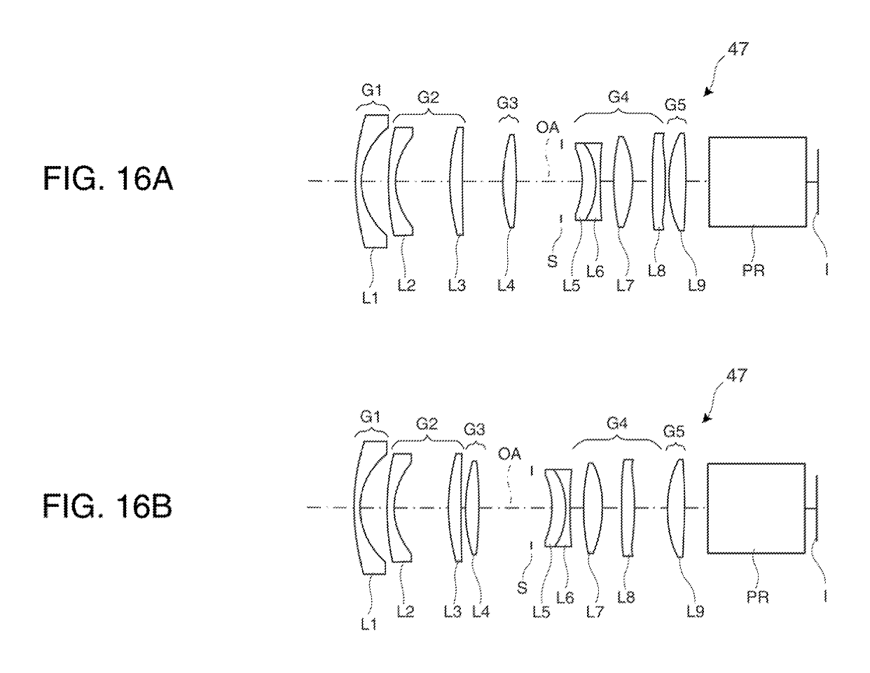

FIG. 16A is a cross-sectional view of the projection zoom lens 47 according to Reference Example operating at the wide angle end, and FIG. 16B is a cross-sectional view of the projection zoom lens 47 according to Reference Example operating at the telescopic end. The projection zoom lens 47, which enlarges and projects an image formed on each projected surface I at a variable magnification, is similar to the projection zoom lens 41 according to Example 1. The projection zoom lens 47 includes a first lens group G1 having negative power, a second lens group G2 having negative power, a third lens group G3 having positive power, an aperture stop S, a fourth lens group G4 having positive power, and a fifth lens group G5 having positive power sequentially arranged from the high magnification side. To change the magnification, the first lens group G1 and the fifth lens group G5 are fixed and the second lens group G2, the third lens group G3, the fourth lens group G4, and other lens groups, which are movable lens groups, are moved for scorning, and to bring a subject into focus, the first lens group G1 is moved for focusing.

The first lens group G1 includes a single lens, that is, a negative meniscus lens L1 having a convex surface facing the high magnification side. The second lens group G2 is formed of the following two lenses: a negative meniscus lens L2 having an aspheric surface on both sides one of which is a convex surface facing the high magnification side; and a positive meniscus lens L3 having a convex surface facing the high magnification side. The third lens group G3 includes a single lens, that is, a biconvex positive lens L4. The fourth lens group G4 is formed of the following four lenses: a doublet, formed of a positive meniscus lens L5 having a concave surface facing the high magnification side and a biconcave negative lens L6; a biconvex positive lens L7; and a positive meniscus lens L8 having an aspheric surface on both sides one of which is a convex surface facing the low magnification side. The fifth lens group G5 includes a single lens, that is, a biconvex positive lens L9.

The negative meniscus lens L2 in the second lens group 62 and the positive meniscus lens L8 in the fourth lens group G4 are resin lenses, which means that two resin lenses having oppositely signed power factors are disposed on opposite sides of the aperture stop S.

### SUMMARY OF EXAMPLES

Table 29 shows the amount of focus shift produced at the wide angle end, the telescopic end, and other positions when the overall temperature of each of the projection zoom lenses uniformly increases by +20° C.

The numerical examples show the coefficients of linear expansion of the materials of the glass lenses and the resin lenses, and in the calculation of the inter-lens distances, the amounts of focus shift were calculated, by assuming that lens frames had a uniform coefficient of linear expansion of 350×10⁻⁷.

It general, an acceptable depth of focus is determined by using the fnumber and the circle of least confusion. Assuming that the diameter of the circle of least confusion produced by each of the projection zoom lenses according to Examples is about 12 μm, the depth of focus is about 20 μm is at the wide angle end and about 25 μm at the telescopic end in Examples.

TABLE 29

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Wide angle end | −10.8 | 4.6 | −2.6 | −7.5 | 7.3 | 0.1 |
| Telescopic end | −10.6 | 7.9 | −7.6 | 7.8 | −6.7 | −22.6 |

Table 29 clearly shows that when the temperature uniformly increases by +20° C., the focus shifts well fail within the depths of field in Examples 1 to 6, and almost no disadvantageous effect caused by the uniform increase in temperature is seen.

Table 30 shows the amount of focus shift produced when there is a temperature distribution in each of the projection room lenses.

TABLE 30

| | Temperature increased | | Temperature distribution | |
|---|---|---|---|---|
| | uniformly by +20° C. | | was present. | |
| | Example | Reference | Example | Reference |
| | 1 | Example | 1 | Example |
| Wide angle | −10.8 | −4.7 | −3.6 | 35 |
| end | | | | |
| Telescopic | −10.6 | −11.8 | 1.2 | 40.1 |
| end | | | | |

In general, the temperature inside the projection zoom lens 40 tends to be distributed as follows: A portion in the vicinity of the aperture stop S has the highest temperature because light rays are focused there; a portion on the low magnification side where the liquid crystal panel is present has relatively high temperature; and a portion on the high magnification side has the lowest temperature not only because light fluxes diverge but also because the atmosphere cools the temperature. In view of the fact, the temperature is assumed to be so distributed in the wide angle end state that the temperature in the position of the lens located on the enlargement side increases by +100° C., the temperature in the position of the aperture stop increases by +40° C., and the temperature in the vicinity of the center of the prism increases by +20° C. The amount of focus shift calculated under the condition described above is compared between Example 1 and Reference Example in Table 30 shown above.

As shown in the left fields in Table 30, when the temperature uniformly increases by +20° C., the amounts of focus shift due to the increase in temperature is about 10 μm at the maximum both in Example 1 and Reference Example, which well falls within the acceptable depth of focus. When there is a temperature distribution in each of the projection zoom lenses, the right fields in Table 30 show that the amount of focus shift does not increase but advantageously decreases in Example 1, whereas the focus is shifted by at least +30 μm in Reference Example, which does not fall within the depth of focus and local or overall blur is disadvantageously viewed on the screen.

Table 31 shown below summarizes numerical data on the conditional expression (1) in Examples 1 to 6.

TABLE 31

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Rn/Rp | 0.622 | 0.496 | 0.386 | 0.119 | 0.336 | 0.207 |

The invention is not limited to the embodiment and examples described above but can be implemented in a variety of aspects to the extent that they do not depart from the substance of the invention.

For example, in Examples 1 to 6, at least one lens having no effective power can be added to each of the lens groups G1 to G5 (G6, G7) in a position upstream or downstream of any lens therein or between any lenses therein.

The projection zoom lens 40 can enlarge and project not only images formed on the liquid crystal panels 16G, 18R, and 18B but also images formed on digital micromirror devices that use micromirrors as pixels or a variety of other light modulation devices.

The entire disclosure of Japanese Patent Application No, 2011-227663, filed Oct. 17, 2011 is expressly incorporated by reference herein.

What is claimed is:

1. A projection zoom lens comprising at least the following three lens groups:
a first lens group disposed on the enlargement side, fixed at the time of zooming, and having negative power;
a last lens group disposed on the reduction side, fixed at the time of zooming, and having positive power; and
a movable lens group disposed between the first lens group and the last lens group and moved for zooming,
wherein the projection room lens is substantially telecentric on the low magnification side,
an aperture stop is provided in the movable lens group provided for the zooming,
a plurality of resin lenses are provided, across the first lens group to the last lens group, and
at least two resin lenses having oppositely signed power factors among the plurality of resin lenses are disposed in a lens group on the high magnification side with respect to the aperture stop.

2. The projection scorn lens according to claim 1,
wherein the at least two resin lenses having oppositely signed power factors are disposed in a single lens group.

3. The projection zoom lens according to claim 1,
wherein the at least two resin lenses having oppositely signed power factors are disposed in lens groups disposed adjacent to each other.

4. The projection zoom lens according to claim 1,
wherein the at least two resin lenses having oppositely signed power factors are disposed adjacent to each other.

5. The projection zoom lens according to claim 1,
wherein the at least two resin lenses having oppositely signed power factors are a negative resin lens having negative power and a positive resin lens having positive power sequentially arranged from the high magnification side.

6. The projection zoom lens according to claim 5,
wherein the negative resin lens disposed on the high magnification side and having negative power is a negative lens having a concave surface facing the low magnification side, and the positive resin lens disposed on the low magnification side and having positive power is a positive lens having a convex surface facing the high magnification side.

7. The projection zoom lens according to claim 6,
wherein when the low-magnification-side concave surface of the negative resin lens disposed on the high magnification side and having the negative power has a radius of curvature Rn, and the high-magnification-side convex surface of the positive resin lens disposed on the low magnification side and having the positive power has a radius of curvature Rp, the following conditional expression is satisfied;
0.0<Rn/Rp<1.0.
